(19) United States
(12) Patent Application Publication
(10) Pub. No.: US 2016/0072433 A1
(43) Pub. Date: Mar. 10, 2016

(54) Multiple Configurable Solar Photovoltaic Assembly

(71) Applicant: Jerry Sorgento, Clarksburg, NJ (US)

(72) Inventor: Jerry Sorgento, Clarksburg, NJ (US)

(21) Appl. No.: 14/827,372

(22) Filed: Aug. 17, 2015

Related U.S. Application Data
(63) Continuation-in-part of application No. 13/910,537, filed on Jun. 5, 2013, now abandoned.

(51) Int. Cl. H02S 40/36; H02S 40/34; H02S 30/10; H02S 20/30; H02S 30/20

(52) U.S. Cl. CPC H02S 40/36; H02S 20/30; H02S 30/20; H02S 30/10; H02S 40/34

(57) ABSTRACT

A portable multiple configuration solar photovoltaic assembly is disclosed. The assembly contains a plurality of solar photovoltaic panels that collect solar energy and convert the solar energy into electricity. The present invention provides an XJR-junction box that allows for the assembly to be used in either an in-series or in-parallel wiring configuration.

### PRIORITY CLAIM

This application claims priority to and is a continuation-in-part of co-pending U.S. patent application Ser. No. 13/910,537. The disclosure, specifications and drawings of that application are incorporated herein by reference.

### BACKGROUND OF THE INVENTION

The present invention is directed to the field of portable installation of photovoltaic solar panels for generating electricity. In particular, the present invention is directed to an improvement on existing installations, such that the modules can be used interchangeably between an in-series and in parallel wing configuration. This allows for use in high power utility grade installations as well as lower power installations which is not possible with presently available units. In addition, the frame for supporting the solar modules comprises an integrated windscreen.

### BRIEF DESCRIPTION OF THE DRAWINGS IN THE SPECIFICATION

FIG. 1a is a front view of an embodiment of the device of the present invention.

FIG. 1b is a side view of an embodiment of the device of the present invention.

FIG. 2 is a back view of an embodiment of the device of the present invention.

FIG. 3 is a front view illustrating a component of the present invention.

FIG. 4 is a partial cut-away view illustrating a component of the present invention.

FIG. 5 is a detail view illustrating a component of the present invention.

FIG. 6 is a side view illustrating an embodiment of the device of the present invention.

FIG. 7 illustrates an alternate installation of the present invention.

FIG. 8 is a detail view illustrating a component of the present invention.

FIG. 9 is a detail view illustrating a component of the present invention.

FIG. 10a is a back view illustrating a component of the present invention.

FIG. 10b is a side view of the component in FIG. 10a.

FIG. 11a is a front cutaway detail view of a component of the present invention.

FIG. 11b is a side view of the component illustrated in FIG. 11a.

FIG. 12a is a rear view of a component of the present invention.

FIG. 12b is side view of the component illustrated in FIG. 12a.

FIG. 12c is a detail view of part of FIG. 12b.

FIG. 13a is a rear view of a component of the present invention.

FIG. 13b is a top view of a component of the present invention.

FIG. 14a is a front view of an alternate embodiment of the present invention.

FIG. 14b is a side view of an alternate embodiment of the present invention.

FIG. 15a is a rear view of a component of an alternate embodiment of the patent invention.

FIG. 15b is a side view of a component of an alternate embodiment of the present invention.

FIG. 16 is a plan view of a component of an alternate embodiment of the present invention.

FIG. 17a is a detail view of a component of an alternate embodiment of the present invention.

FIG. 17b is a detail view of a component of an alternate embodiment of the present invention.

FIG. 18b is a detail view of the operation of a component of an alternate embodiment of the present invention.

FIG. 18b is a detail view of a component of an alternate embodiment of the present invention.

FIG. 19 illustrates the operation of a component of an alternate embodiment of the present invention.

FIG. 20 is a plan view illustrating an installation of the alternate embodiment of the present invention.

FIG. 21 is a side assembly view of the alternate embodiment of the present invention.

FIG. 22a is a side assembly view of the alternate embodiment of the present invention.

FIG. 22b is a side assembly view of the alternate embodiment of the present invention.

FIG. 23 is a plan view of a component of an alternate embodiment of the present invention.

FIG. 24 is a partial assembly view component of an alternate embodiment of the present invention.

FIG. 25 is a plan view illustrating an installation of the alternate embodiment of the present invention.

FIG. 26 is a drawing of a Configurable Photovoltaic Assembly of the foundation of this Invention. All Photovoltaic Modules (39) use WEEB-type Washers when being attached to the Main Frame (35) to create a Bonding Pass through the Main Frame (35).

FIG. 27 is a drawing of a Starter Plug (22) showing the internal wiring of Starter Plug (22).

FIG. 28 is a drawing of the XJR Junction Box-Right (12) and the XJR Junction Box Left (17) showing mechanical connectors (2) (6), Photovoltaic Connectors (19) (4) and a series of wiring and grounding procedures.

FIG. 29 is a drawing showing the XJR Junction Box-Right (12) and the XJR Junction Box-Left (17) with the internal Trunk Cable (16), Photovoltaic Connectors (19) (4) representing four Photovoltaic Modules (20) (21) and all the related wiring of this Invention.

FIG. 30 is a drawing showing one of the intended uses of this invention being installed and wired in an In-series Wiring Configuration for a Large Utility Grade Installation where the voltage increases and the amperage is maintained at a low level. Note that a Starter Plug (22) is required to achieve this. This rear view drawing shows that when the Starter Plug (22) is used on the Left End of a twelve Photovoltaic Module Array, the Negative Current is passed from the #4 Pin (24) to the #3 Pin (25) using a Jumper Wire (23). The #3 Wire carries the Negative Current to the other end of the String where it is passed to a trunk cable that carries the Current to the Combiner/Inverter. It also shows that when the Starter Plug (22) is used on the Right Side, the Positive Current using a Jumper Wire (32) is passed from the #1 Pin (31) to the #2 Pin (30), and the #2 Wire carries the Positive Current to the other end of the twelve Photovoltaic Module Array where it is then passed to a trunk cable that carries the Current to the Combiner/inverter.

FIG. 30A is a drawing showing that the 4-Conductor Color-Coded Trunk Cable (41) does not receive a wire from the #4 Pin on the RED Color-Coded Connector (6) on the XJR Junction Box-Right Side (12) and does not receive a wire from the #1 Pin on the Connector (2) of XJR Junction Box-Left Side (17). It also shows that the Wire from the XJR Junction Box-Right Side (12) #1 Pin of RED Color-Coded Connector (6) goes to the #4 Pin in Connector (2) of the XJR Junction Box-Left Side (17). There is no wire connected to the #4 Pin in RED Color-Coded Connector (6) XJR Junction Box-Right Side (12) from the 4-Conductor Color-Coded Trunk Cable (41) and there is no wire connected to the #1 Pin Connector (2) in the XJR Junction Box-Left Side (17) from the 4-Conductor Color-Coded Trunk Cable (41). The drawing also shows a 4-Conductor Color-Coded Trunk Cable (41) used only in an In-series Wiring Configuration installation.

FIG. 31 is a more detailed drawing showing how the Starter Plug (22) is used on the Left Side of a Three PPG Array, the 4-Conductor Color-Coded Trunk Cable (41) transfers the current from the XJR Junction Box-Right Side (12) to the XJR Junction Box-Left Side (17) when connecting a PPG to another PPG with the wiring configuration being in an In-series Wiring Configuration. The drawing also shows the use of the Invention when the power is going from Left to Right using the Starter Plug (22) to direct the Current Flow.

FIG. 32 is a more detailed drawing showing how when the Starter Plug (22) is used on the Right Side of the three PPG Array, the 4-Conductor Color-Coded Trunk Cable (41) passes the Current from the XJR Junction Box-Left Side (17) to the XJR Junction Box-Right Side (12) of the next PPG. The drawing also shows the use of this Invention when the power is going from Right to Left using the Starter Plug (22) to direct the Current Flow.

FIG. 33 is a drawing showing two PPGS being connected in an Configuration with no Starter Plug (22) needed. It also shows one of the intended uses of this Invention being wired and installed in an In-parallel Wiring Configuration with another similarly wired unit so that the voltage will be controlled at a low volume but allowing the amperage to double its volume.

FIG. 34 is a drawing showing the Invention in a Closed Travel Configuration thus showing the way the Main Frame (35) and the Base Frame (53) encapsulate the Photovoltaic Modules (39) as a protective measure.

FIG. 35 is a drawing showing the Invention with all of the Components that make up the Built-in Fold-out Windscreen Invention (48).

FIG. 36 is a drawing showing how the Windscreen invention (48) is located when folded into the Main Frame (35).

FIG. 37 is a drawing showing the Windscreen Invention (48) in the Folded and Unfolded Configurations and identifies the locations of the Master Hinge (52) and the Quick Release Quick Detachable Caster Wheel Assembly (55).

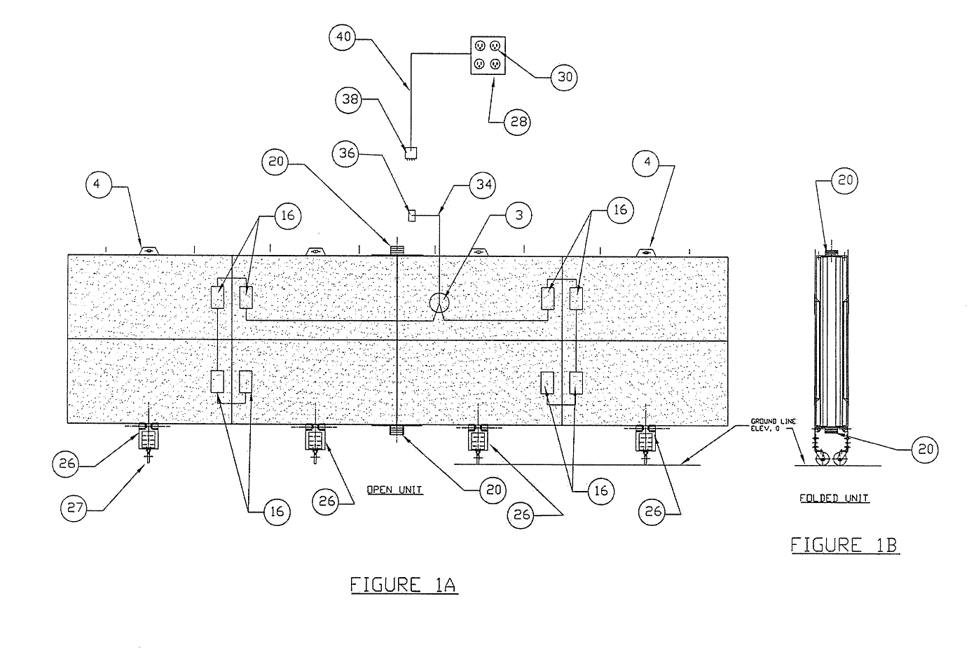

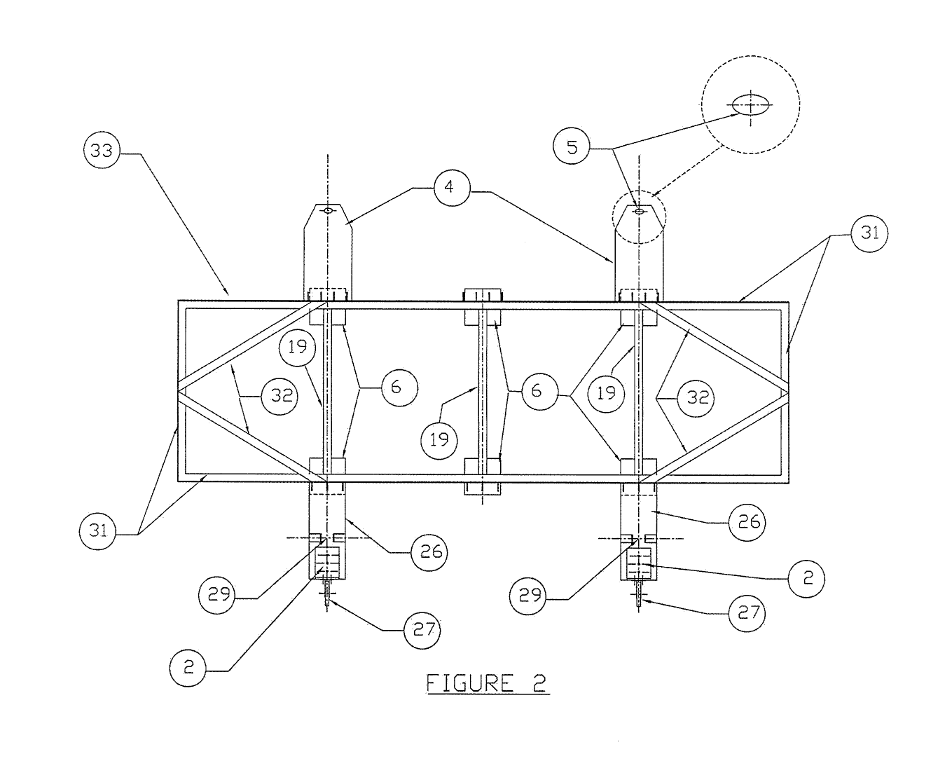

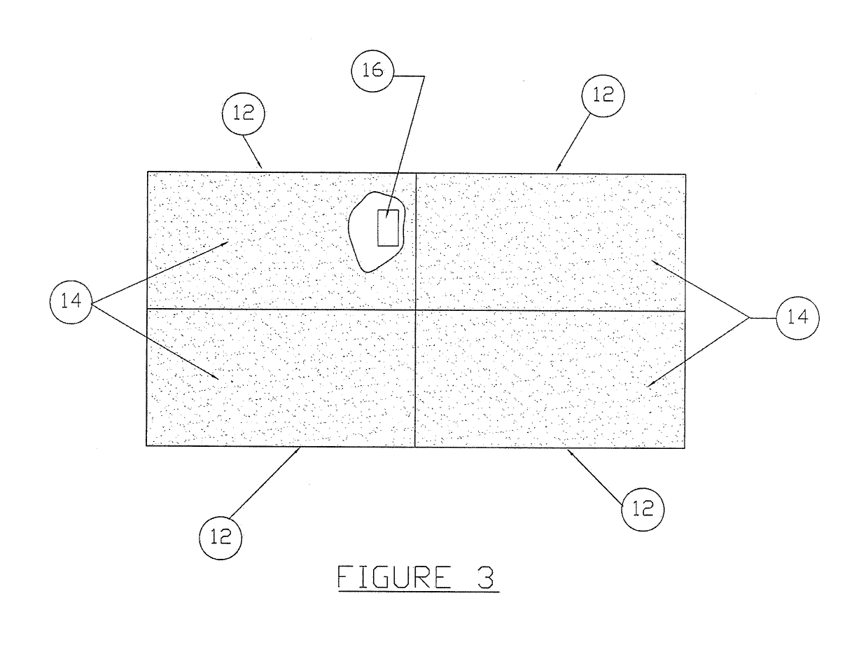

### SUMMARY OF THE INVENTION

This present Invention is a New Multiple Configurable Solar Photovoltaic Assembly created for installation method(s) by preassembling Photovoltaic Modules together using its Built-in Frame which, when unfolded, presents a labor-free installation suitable for Large Utility Grade Installations while eliminating over 90% of labor, ground site improvements and material handling. The Invention has built-in anti-theft devices, requires no tools and no added ballast for stability. This Invention will reduce construction time of a traditional megawatt installation by more than 85%.

The main elements of the present invention are:

1. Built-in Fold-out Windscreen.

2. Folded PPG which has a skeletal protective covering from Base Frame and Main Frame for the Photovoltaic Modules.

3. Quick Release Quick Detachable Caster Wheel Assembly as an Anti-theft adaptation.

4. XJR Junction Box which offers the ability to go from an In-series Wiring Configuration providing high voltage with low amperage to an In-parallel Wiring Configuration providing low voltage with high amperage while providing a Clean Bonding Pass from the first of a twelve Photovoltaic Module String to a Distant Grounded Combiner/Inverter without any additional changes, adjustments or added parts after initial installation.

This Invention consists of a Main Frame with four 250 Watt Photovoltaic Modules attached and grounded to its Main Frame. The Main Frame has two XJR Junction Boxes, one located at each end of the opened Invention. The Invention has a Base Frame which is attached along the front side with four Hinge Assemblies. When in the fully-opened operational configuration, the Main Frame creates an appropriate angle-of-attack to the sun enabling a set of Support Angles to drop into place maintaining that position. Attached to the back of the Support Angles is a Thin Aluminum Sheet designed to act as a Built-in Fold-out Windscreen for the invention.

The internal Wiring of the XJR Junction Box allows the Invention to go from an in-series Wiring Configuration to an In-parallel Wiring Configuration without any changes, adjustments or added parts. The XJR Junction Box also allows for an Absolute Bonding Pass from the very first installed Photovoltaic Module in a string installation, to and beyond the last module in a string installation and ultimately to a Grounded Combiner/Inverter. When taken offline from a Large Utility Grade Installation Site to be used at another site as an Emergency DC Power Supply for Battery Backup Energy Storage and Supply System, the Bonding Pass continues and remains true to a Grounded Battery Backup Enclosure.

This invention has the ability to be removed from a previously wired In-series Wiring Configuration Large Utility Grade Installation by folding into its travel configuration and transported to where emergency power is needed. It can be quickly and easily opened, and with its ability to also be wired in an In-parallel Wiring Configuration for low voltage and higher amperage, it can be plugged into a Battery-Powered Companion Unit to immediately deliver AC power where and when needed.

When the Invention is fully closed and standing on its Quick Release Quick Detachable Caster Wheels, the Base Frame fully encapsulates the Main Frame as a protective skeletal covering. In addition, the Photovoltaic Modules are tucked inside the Main Frame, facing each other, offering added protection for the Photovoltaic Modules by the outside of the Main Frame.

### PPG In-Series to In-Parallel Cabling

The 1000 kW PPG can be strung together as multiple units connected electronically in either an In-series Wiring Configuration or an In-parallel Wiring Configuration.

When strung together in an in-series Wiring Configuration, the 1000 kW PPG is limited to three 1000 kW PPG'S in a string. This Configuration will result in an electrical deliverance of high voltage and low amperage which is well-suited for commercial inverters when used in Large Utility Grade Installations.

When strung together in an In-parallel Wiring Configuration, the 1000 kW PPG can have multiple PPGS in a string. This configuration will result in an electrical deliverance of low voltage and high amperage which is well suited for a Battery Backup Energy Storage and Supply System when used in emergency power conditions. This conversion is achieved with the unique wiring design in the XJR Junction Boxes of the Invention and a simple Trunk Cable manipulation.

By having the ability to quickly and easily go from an In-series Wiring Configuration to an in-parallel Wiring Configuration without any onsite changes, adjustments or added parts, the 1000 kW PPG fulfills its primary design function of being able to be used in a Large Utility Grade Installation, making power while waiting for a call to assist an offsite emergency. When there is a call for an offsite emergency, multiple 1000 kW PPGS can be taken offline, folded into their Travel Configuration and be ready for rapid deployment to bring emergency power to an offsite location where emergency power is needed. When at the Emergency Site, the 1000 kW PPG quickly and easily reconfigures to the In-parallel Wiring Configuration for deliverance of low voltage and high amperage which is necessary for battery backup energy storage systems to deliver emergency power to the end user. All of this requires no additional changes, added parts or any further adjustments beyond the initial installation, providing true Plug-And Play Technology.

### DETAILED DESCRIPTION OF THE INVENTION

### PPG In-Series to In-Parallel Cabling

This present invention will now be described in terms of the presently preferred embodiment thereof as illustrated in the appended drawings. Those of ordinary skill will recognize that obvious modifications may be made thereto without departing from the scope of the present invention.

The 1000 kW PPG can be strung together as multiple units connected electronically in either an In-series Wiring Configuration or an In-parallel Wiring Configuration.

When strung together in an In-series Wiring Configuration, the 1000 kW PPG is limited to three 1000 kW PPG'S in a string. This Configuration will result in an electrical deliverance of high voltage and low amperage which is well-suited for commercial inverters when used in Large Utility Grade Installations.

When strung together in an In-parallel Wiring Configuration, the 1000 kW PPG can have multiple PPGS in a string. This configuration will result in an electrical deliverance of low voltage and high amperage which is well suited for a Battery Backup Energy Storage and Supply System when used in emergency power conditions. This conversion is achieved with the unique wiring design in the XJR Junction Boxes of the invention and a simple Trunk Cable manipulation.

By having the ability to quickly and easily go from an In-series Wiring Configuration to an In-parallel Wiring Configuration without any onsite changes, adjustments or added parts, the 1000 kW PPG fulfills its primary design function of being able to be used in a Large Utility Grade Installation, making power while waiting for a call to assist an offsite emergency. When there is a call for an offsite emergency, multiple 1000 kW PPGS can be taken offline, folded into their Travel Configuration and be ready for rapid deployment to bring emergency power to an offsite location where emergency power is needed. When at the Emergency Site, the 1000 kW PPG quickly and easily reconfigures to the In-parallel Wiring Configuration for deliverance of low voltage and high amperage which is necessary for battery backup energy storage systems to deliver emergency power to the end user. All of this requires no additional changes, added parts or any further adjustments beyond the initial installation, providing true Plug-And Play Technology.

The PPG has a Built-in Fold-out Windscreen which requires no additional changes, added parts or any further adjustments and eliminates the need for ballast in most locations, thus allowing for quick and easy installation time by reducing the need for additional material or equipment to store or install. As the PPG is opened into its Operating Configuration, the Built-in Fold-out Windscreen automatically opens in place. When the PPG is taken offline and folded into its Travel Configuration, the Built-in Fold-out Windscreen, without having to be touched, automatically folds back into place.

The PPG has four Quick Release Quick Detachable Flat Free Swivel Caster Wheels, which also act as an anti-theft device by making it difficult to remove the 380 pound PPG without its wheels. The Quick Release Quick Detachable Caster Wheel Assembly is comprised of an 8″ Flat Free Swivel Caster Wheel which is attached to a mounting box that is held in place by two Positive Locking Pins. When the PPG is located, opened and operating, the two Positive locking Pins are pulled and removed, thus allowing the Quick Release Quick Detachable Caster Wheel Assembly to be quickly and easily detached and stored. If and when the PPG needs to be relocated, the Self-locating Mounting Box is easily slipped into place and, with the two Positive Locking Pins reinserted, the PPG is again instantly ready for rapid deployment to another location; whether back into its original Large Utility Grade installation or at another needed emergency location.

This present Invention is a New Multiple Configurable Solar Photovoltaic Assembly created for installation method(s) by preassembling Photovoltaic Modules together using its Built-in Frame which, when unfolded, presents a labor-free installation suitable for Large Utility Grade Installations while eliminating over 90% of labor, ground site improvements and material handling. The Invention has built-in anti-theft devices, requires no tools and no added ballast. This Invention will reduce construction time of a traditional megawatt installation by more than 85%.

The main elements of the present invention are:

1. Built-in Fold-out Windscreen

2. Folded PPG which has a skeletal protective covering from Base Frame and Main Frame for the Photovoltaic Modules

3. Quick Release Quick Detachable Caster Wheel Assembly as an Anti-Theft adaptation

4. XJR junction Box which offers the ability to go from an in-series Wiring Configuration providing high voltage with low amperage to an In-parallel Wiring Configuration providing low voltage with high amperage while providing a Clean Bonding Pass from the first of a twelve Photovoltaic Module String to a Distant Grounded Combiner/Inverter without any additional changes, adjustments or added parts after initial installation.

This Invention consists of a Main Frame with four 250 Watt Photovoltaic Modules attached and grounded to its Main Frame. The Main Frame has two XJR Junction Boxes, one located at each end of the opened Invention. The Invention has a Base Frame which is attached along the front side with four Hinge Assemblies. When in the fully-opened operational configuration, the Main Frame creates an appropriate angle-of-attack to the sun enabling a set of Support Angles to drop into place maintaining that position. Attached to the back of the Support Angles is a Thin Aluminum Sheet designed to act as a Built-in Fold-out Windscreen for the Invention.

The Internal Wiring of the XJR Junction Box allows the Invention to go from an In-series Wiring Configuration to an In-parallel Wiring Configuration without any changes, adjustments or added parts. The XJR Junction Box also allows for an Absolute Bonding Pass from the very first installed Photovoltaic Module in a string installation, to and beyond the last module in a string installation and ultimately to a Grounded Combiner/Inverter. When taken offline from a Large Utility Grade Installation Site to be used at another site as an Emergency DC Power Supply for Battery Backup Energy Storage and Supply System, the Bonding Pass continues and remains true to a Grounded Battery Backup Enclosure.

This Invention has the ability to be removed from a previously wired In-series Wiring Configuration Large Utility Grade Installation by folding into its travel configuration and transported to where emergency power is needed. It can be quickly and easily opened, and with its ability to also be wired in an In-parallel Wiring Configuration for low voltage and higher amperage, it can be plugged into a Battery-Powered Companion Unit to immediately deliver AC power where and when needed.

When the Invention is fully closed and standing on its Quick Release Quick Detachable Caster Wheels, the Base Frame fully encapsulates the Main Frame as a protective skeletal covering. In addition, the Photovoltaic Modules are tucked inside the Main Frame, facing each other, offering added protection for the Photovoltaic Modules by the outside of the Main Frame.

### Overview

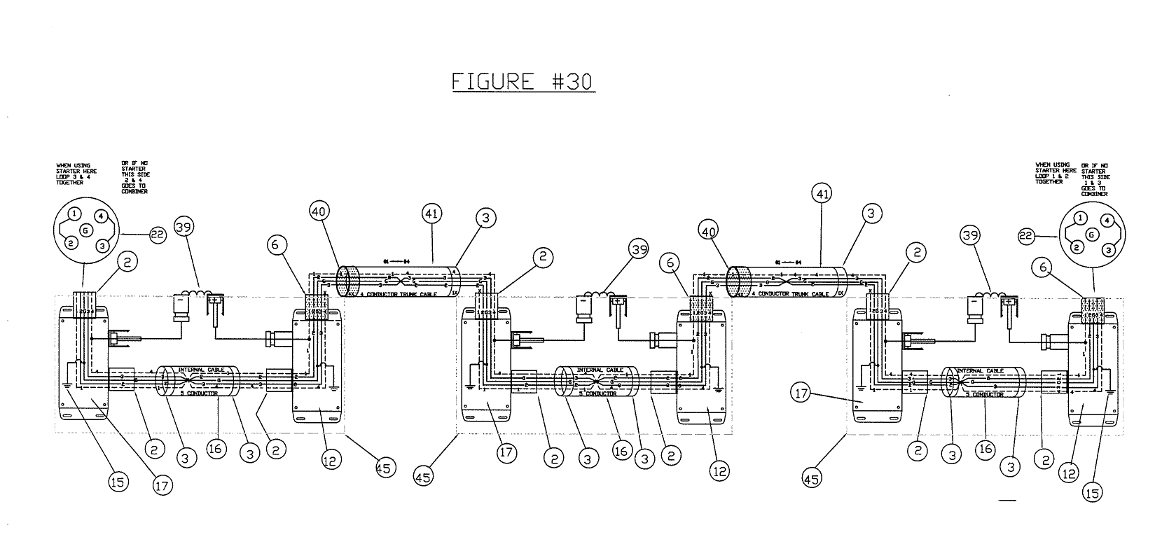

The PPG can be wired in both an In-series Wiring Configuration and In-parallel Wiring Configuration without making any physical changes to the PPG'S mechanical or electrical components. (See FIG. 26)

All Photovoltaic Modules use a WEEB-type washer to create a Bonding Pass to the PPG Frame.

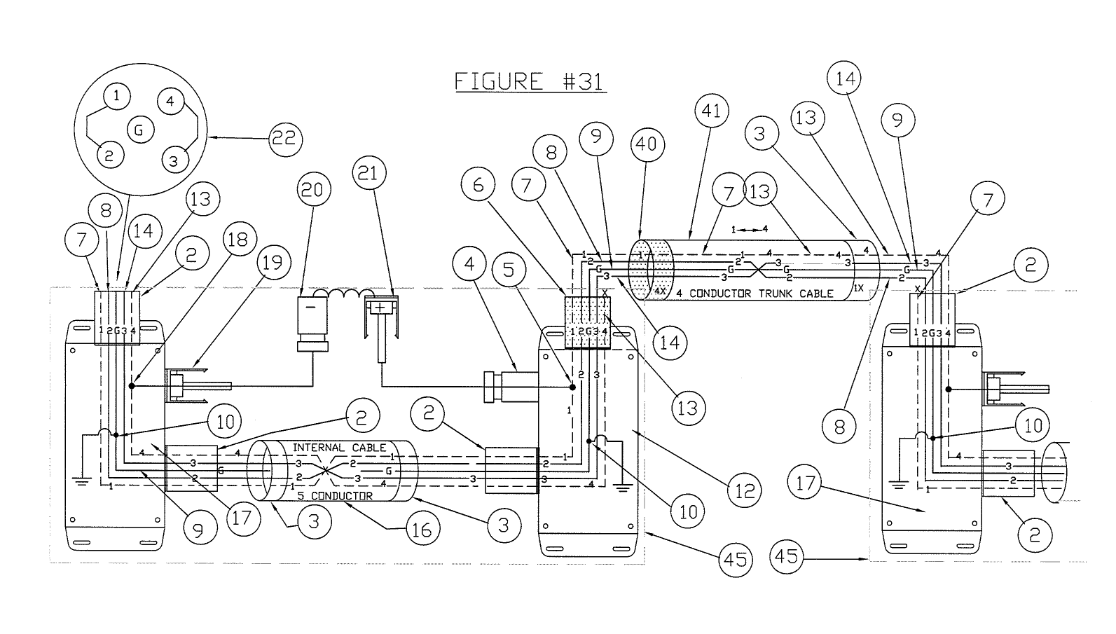

The PPG XJR Junction Boxes, at each end of the PPG, use WEEB-type Washers to pick up the Ground Current from the Main Frame and pass it through the Cover Plate, via the Ground Lug that is pressed into the Cover Plate, to a wire that is spliced into the Ground Wire which runs from the #5 pin of each of the External Five Pin Connectors. This allows for the passing of the Ground Current through the Internal Trunk Cable of each PPG enabling a bonding pass from the first XJR Junction Box in a string of three PPG units to an Interconnecting Trunk Cable running to a Grounded Combiner When being wired in an In-series Wiring Configuration for a Large Utility Grade Installation. (See FIGS. 28, 29, 30).

### XJR Function Box and Internal Wiring

Each XJR Junction Box has two Female 5-Pin Connectors, a Photovoltaic Connector and a Ground Lug that is pressed into the Cover Plate. There are two Positive Wires, two Negative Wires and one Ground Wire passing from an Outside Connector on the side of the XJR Junction Box to an Outside Connector on the top of the XJR Junction Box. (See FIG. 28).

A wire attached to the Ground Lug that is pressed into the Lid of each XJR Junction Box is spliced into the Ground Wire that runs through each XJR Junction Box. (See FIG. 28)

The Side-mounted Female Connectors receive a 5-Conductor Internal Cable that runs from one XJR Junction Box to the other. There is a Photovoltaic-type Connector on the Side of each XJR Junction Box.

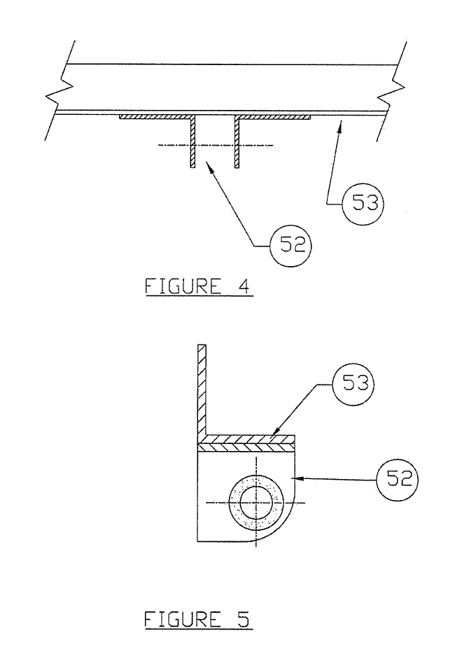

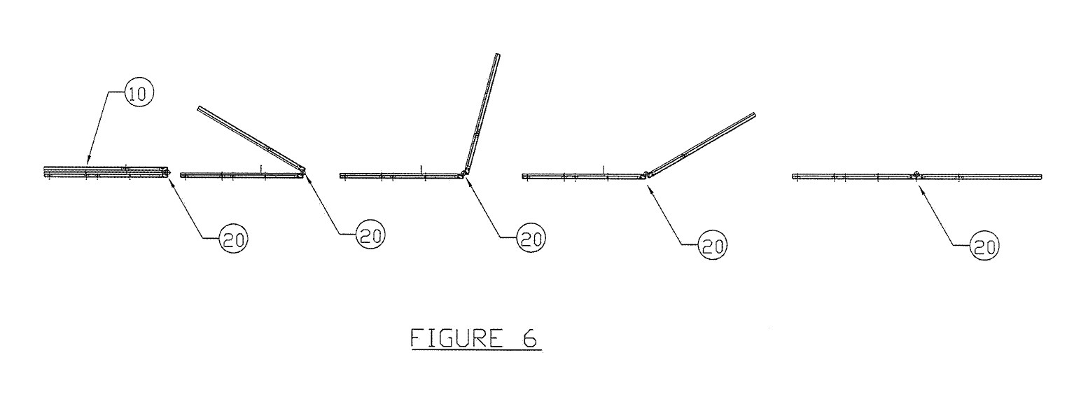

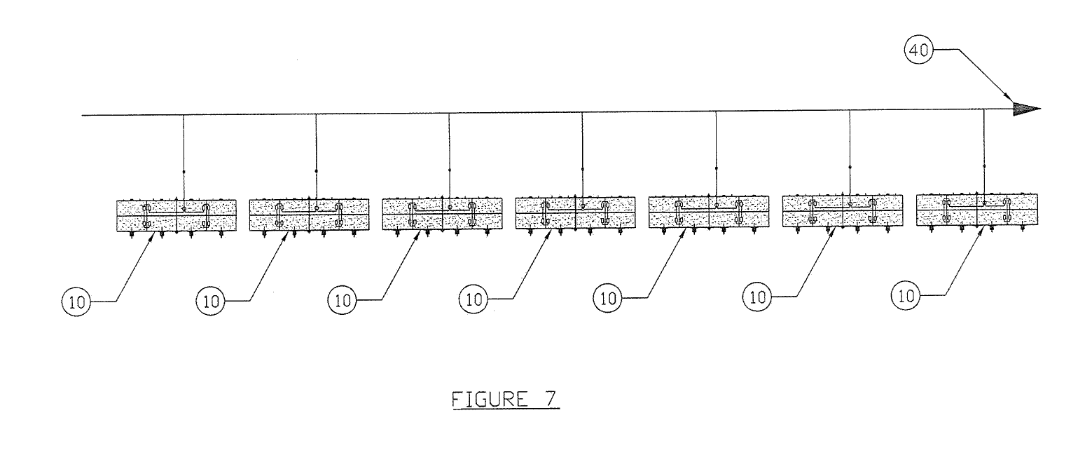

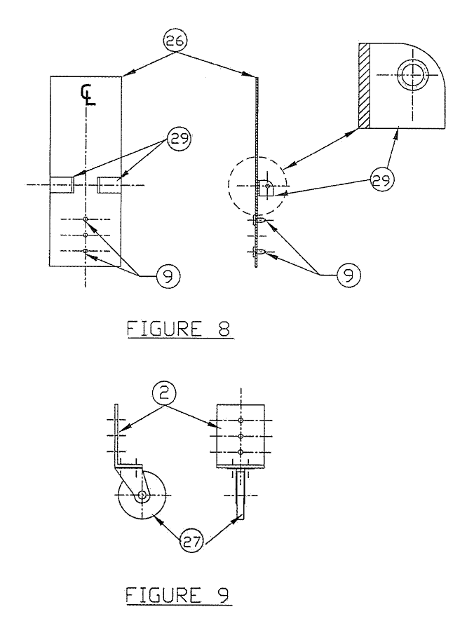

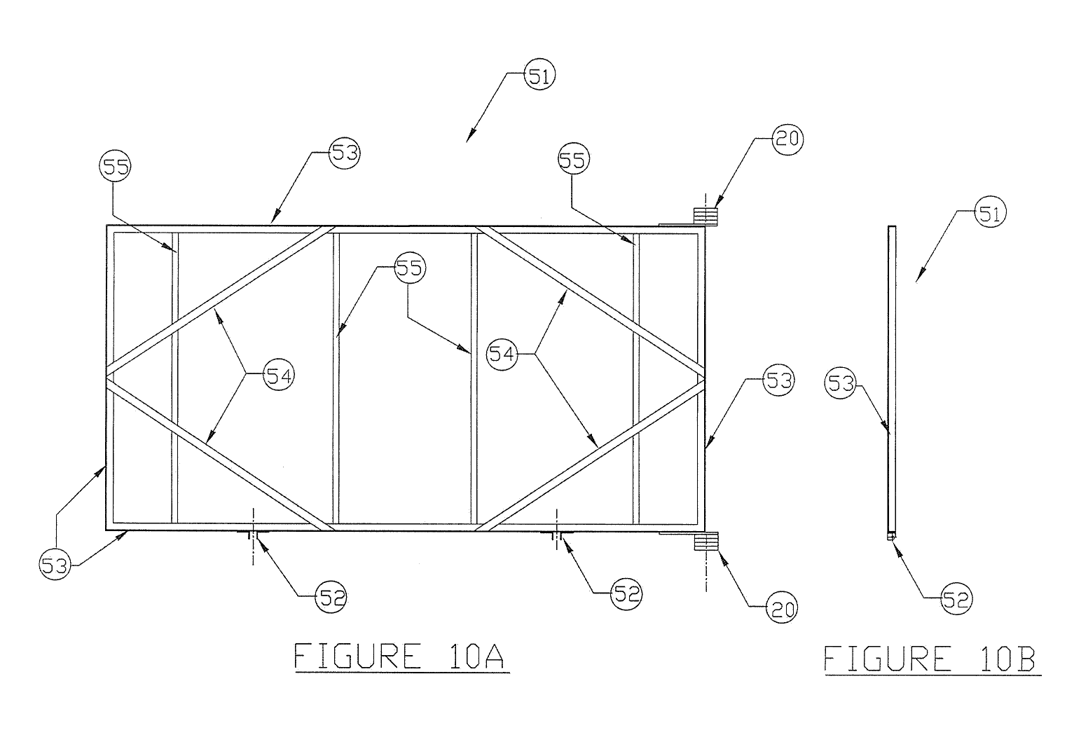

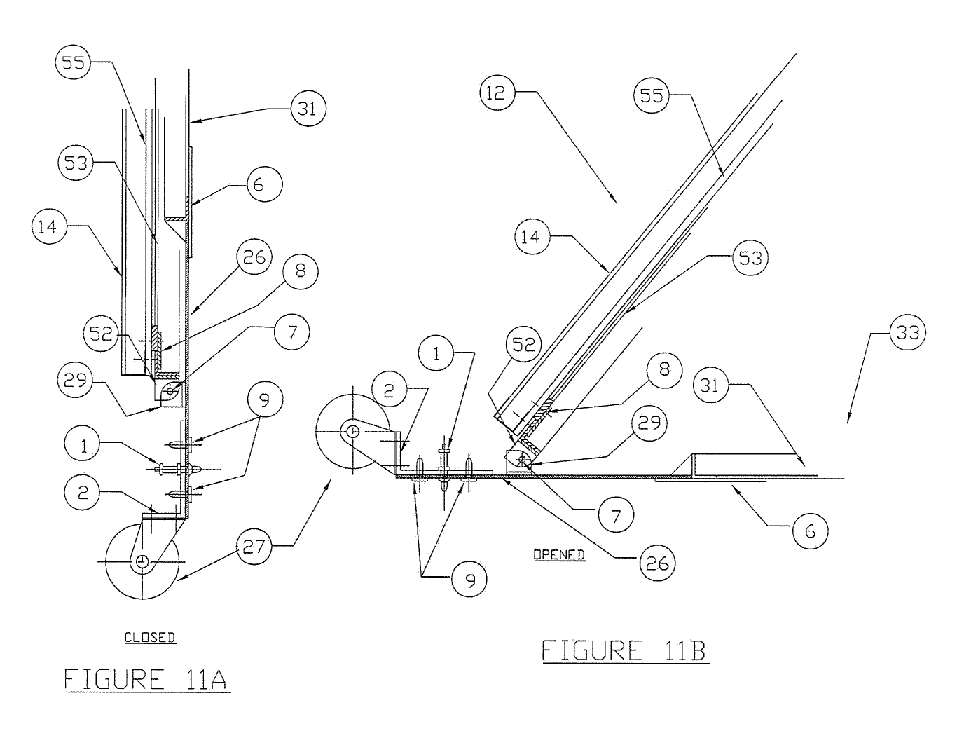

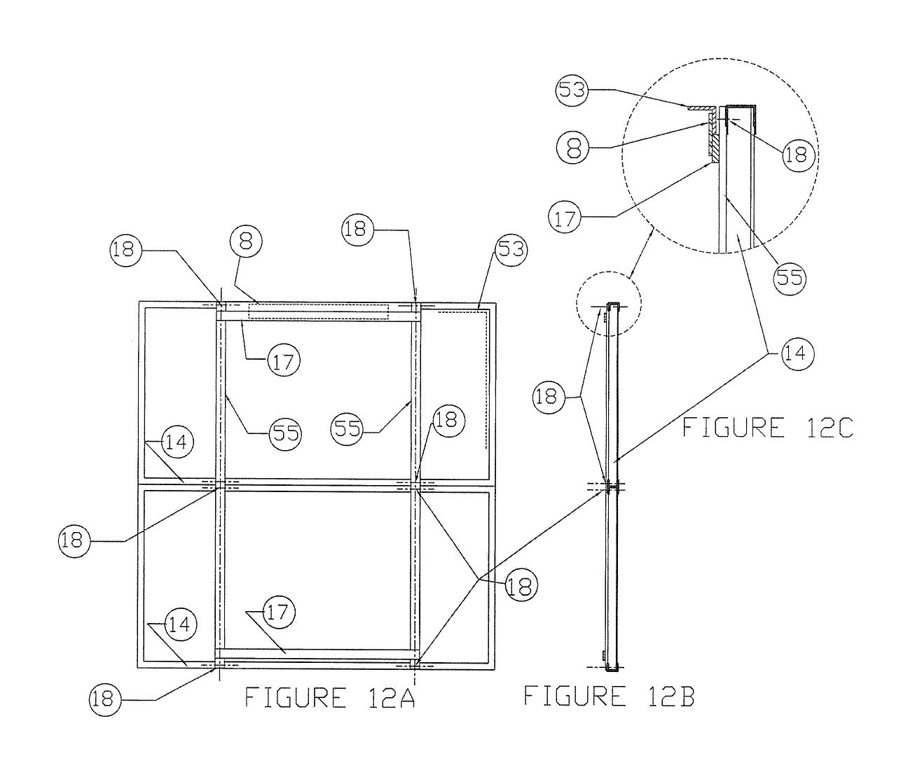

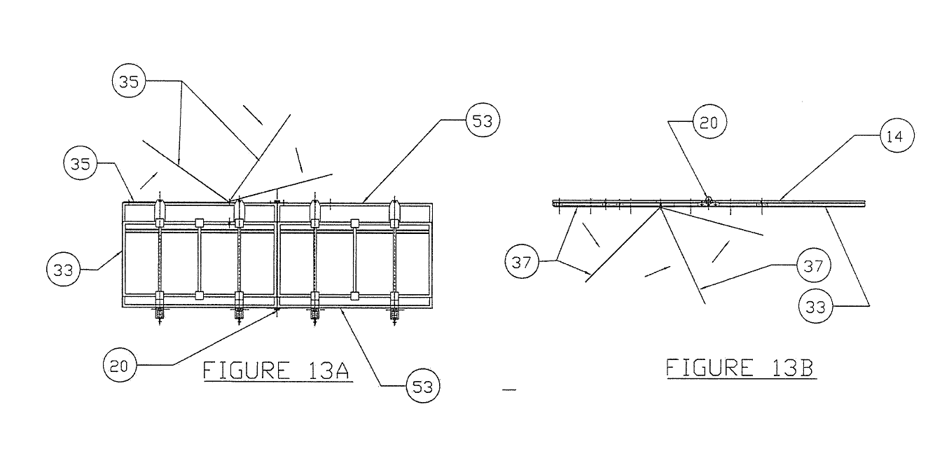

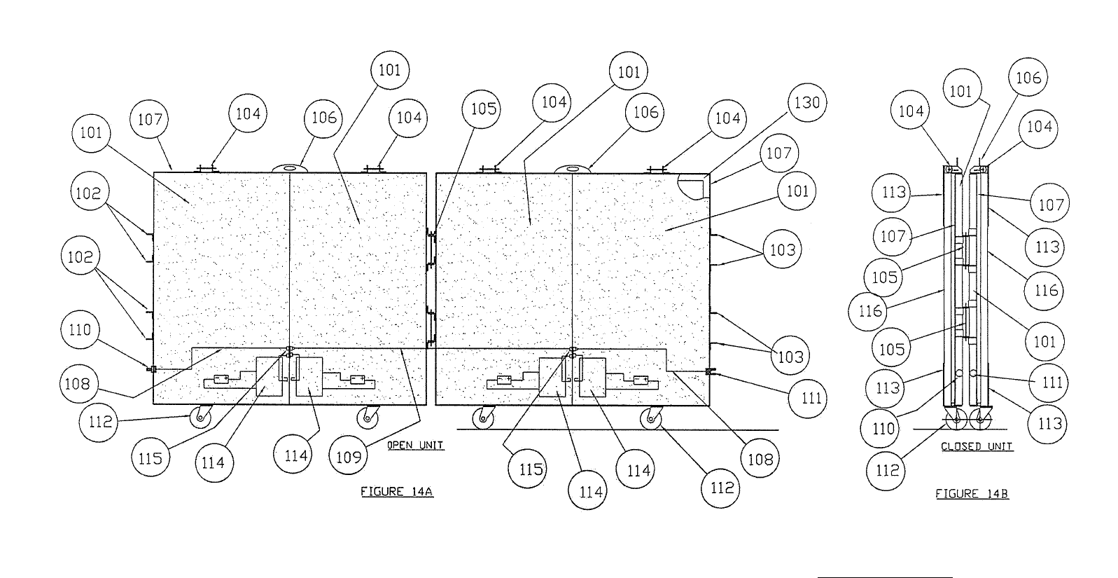

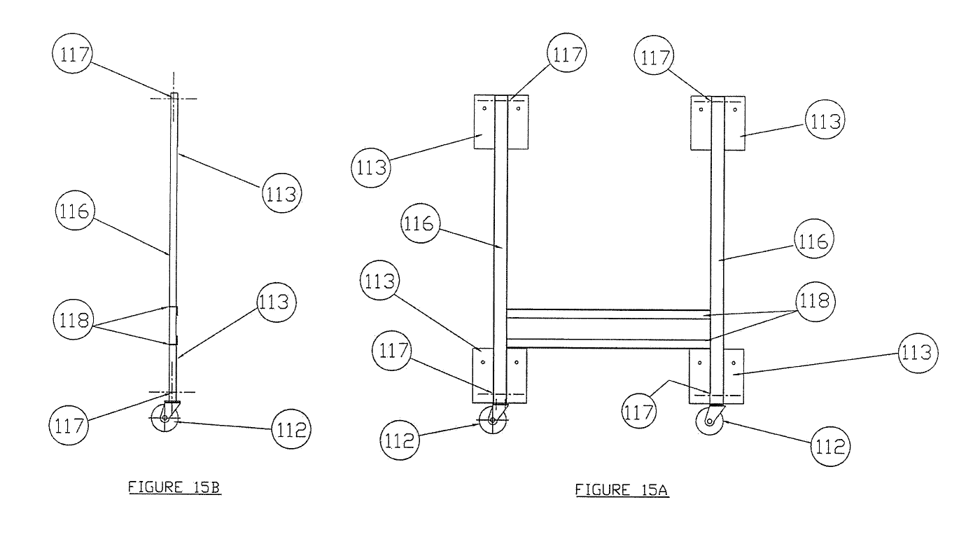

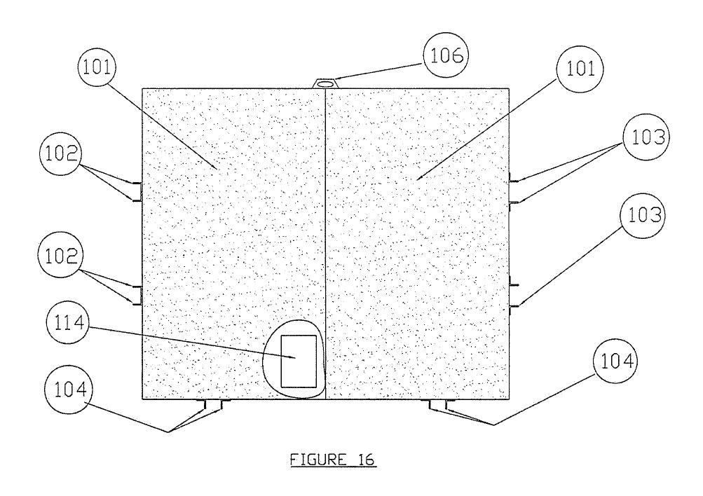

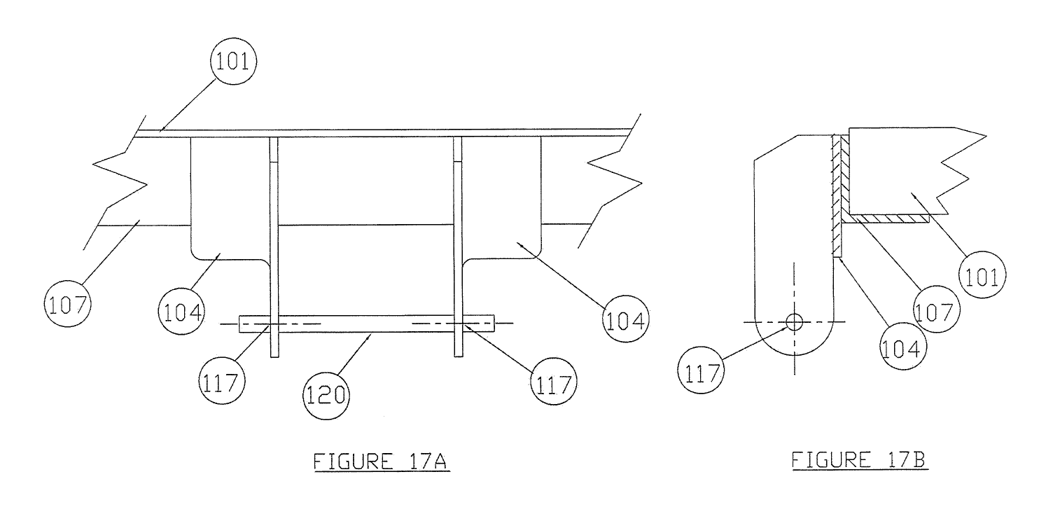

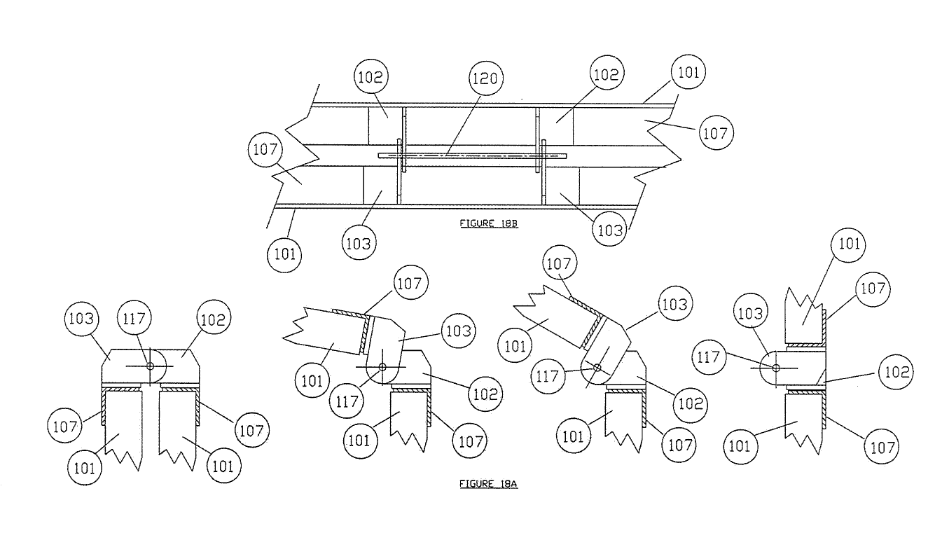

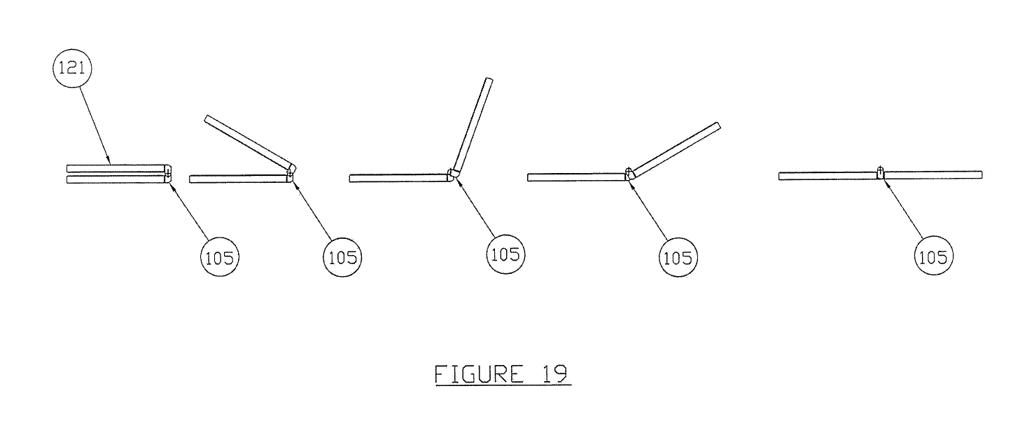

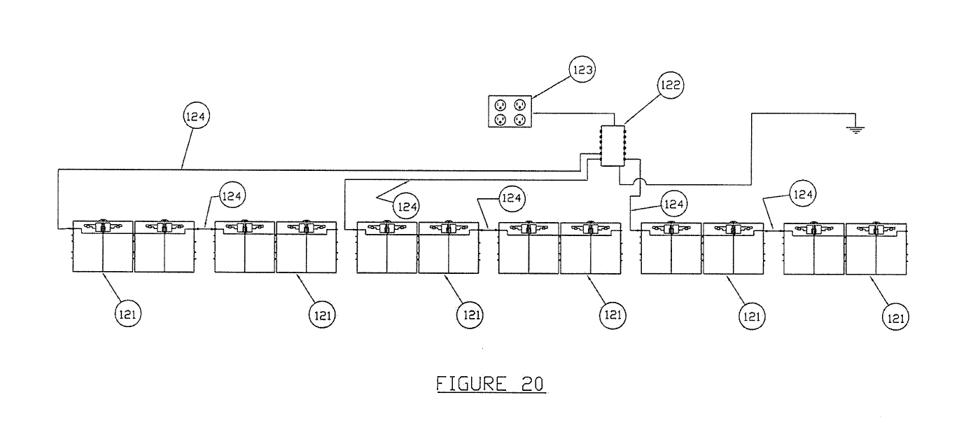

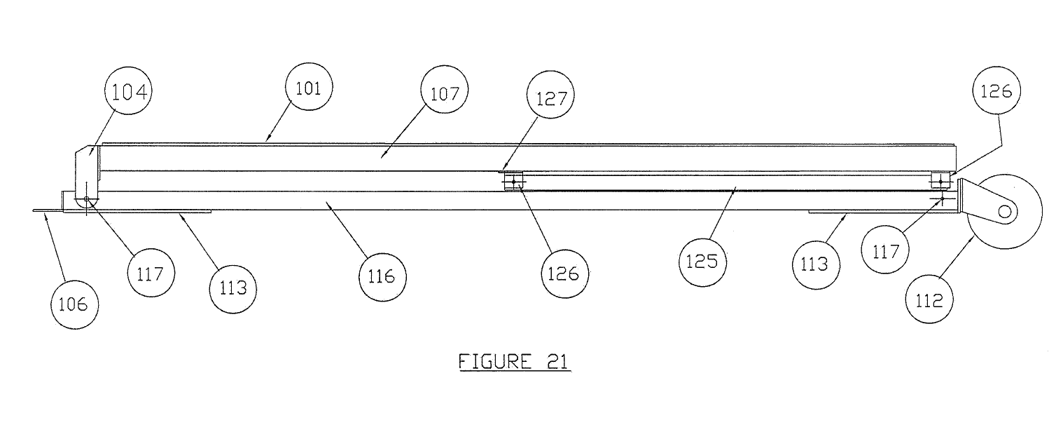

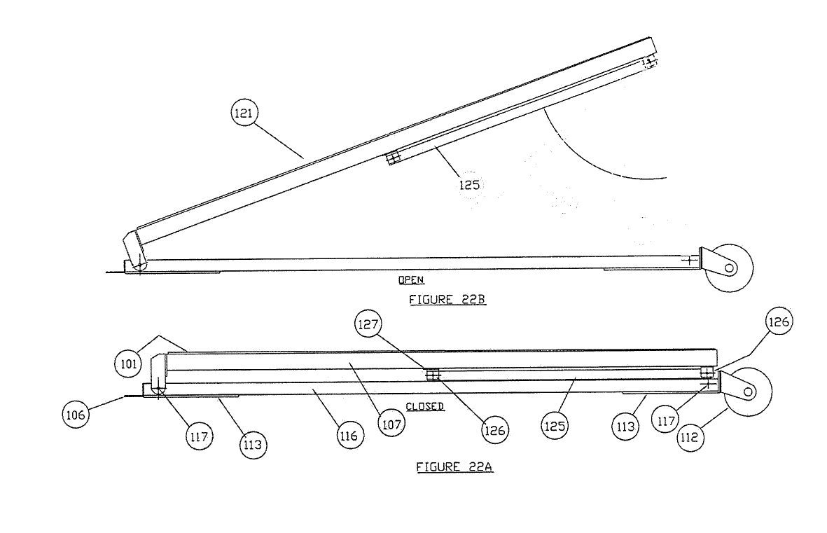

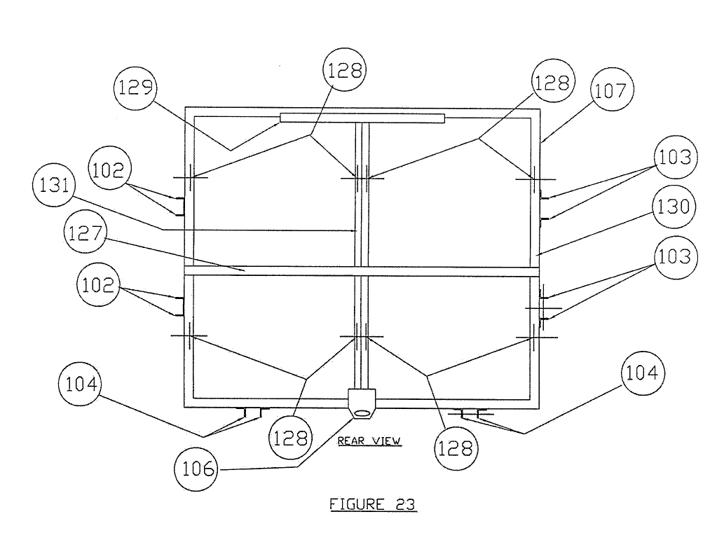

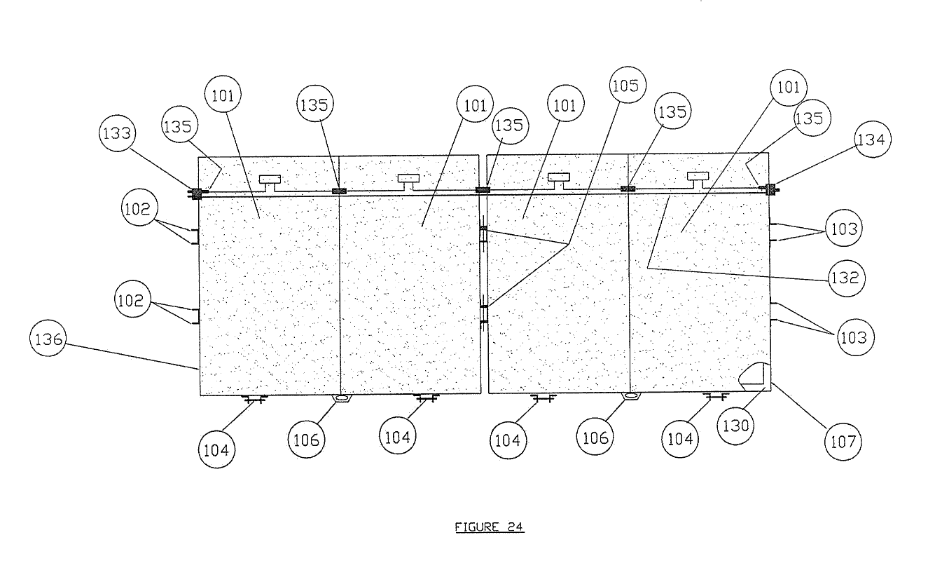

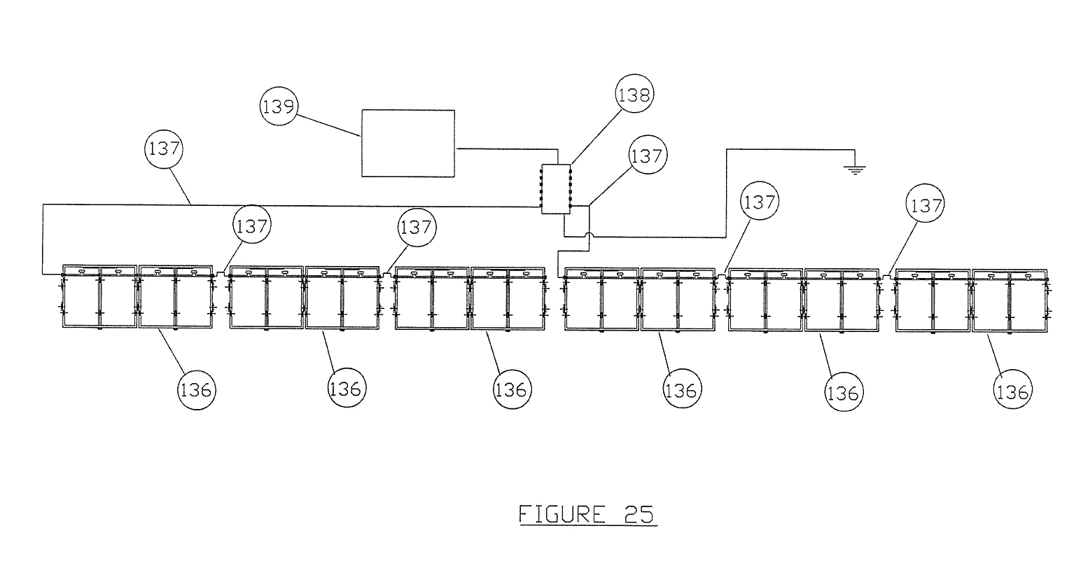

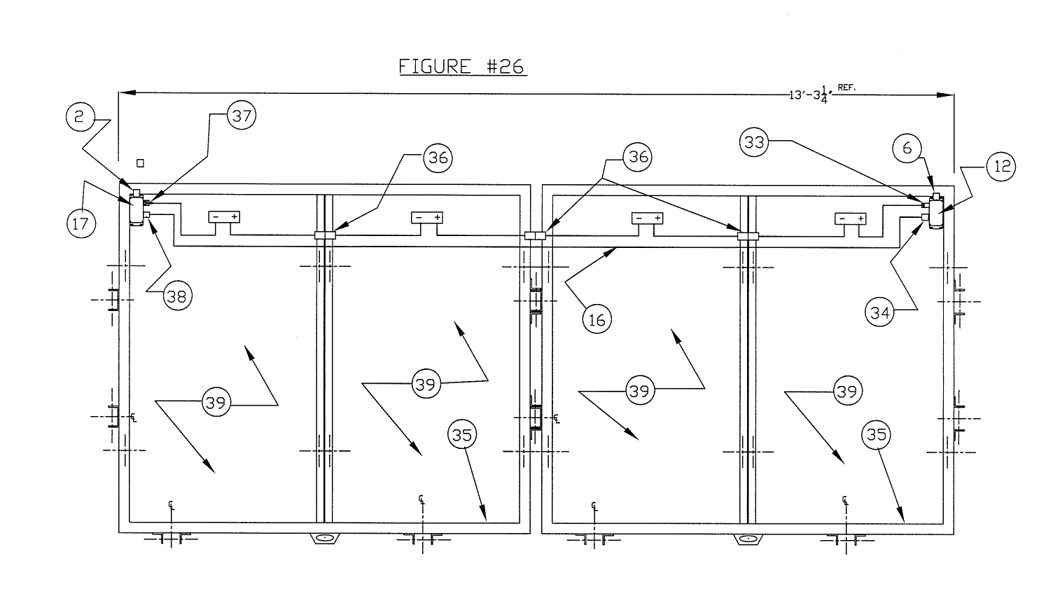

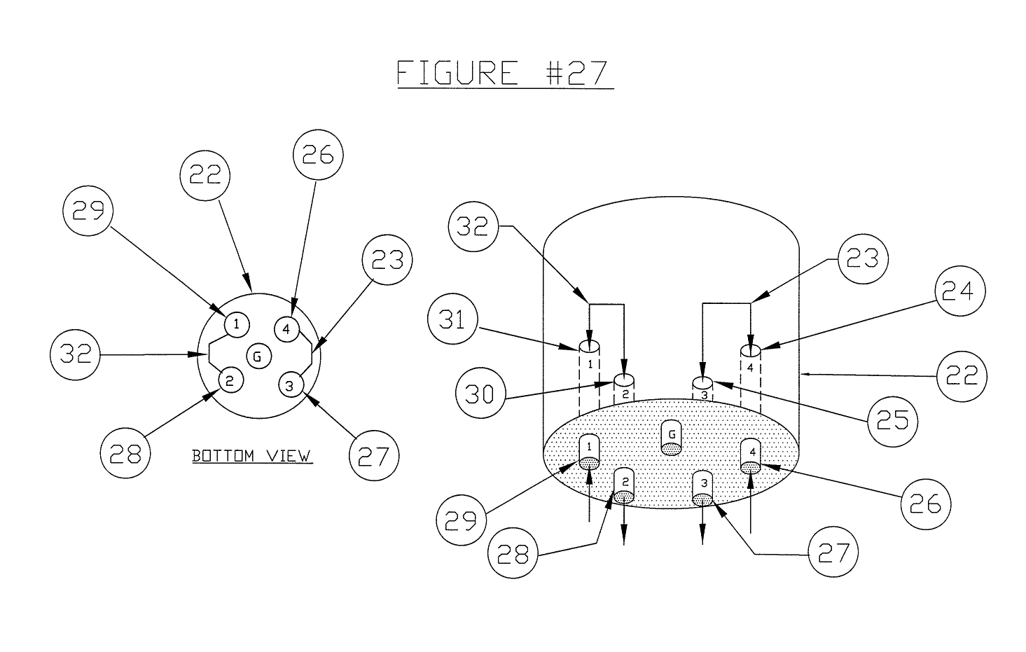

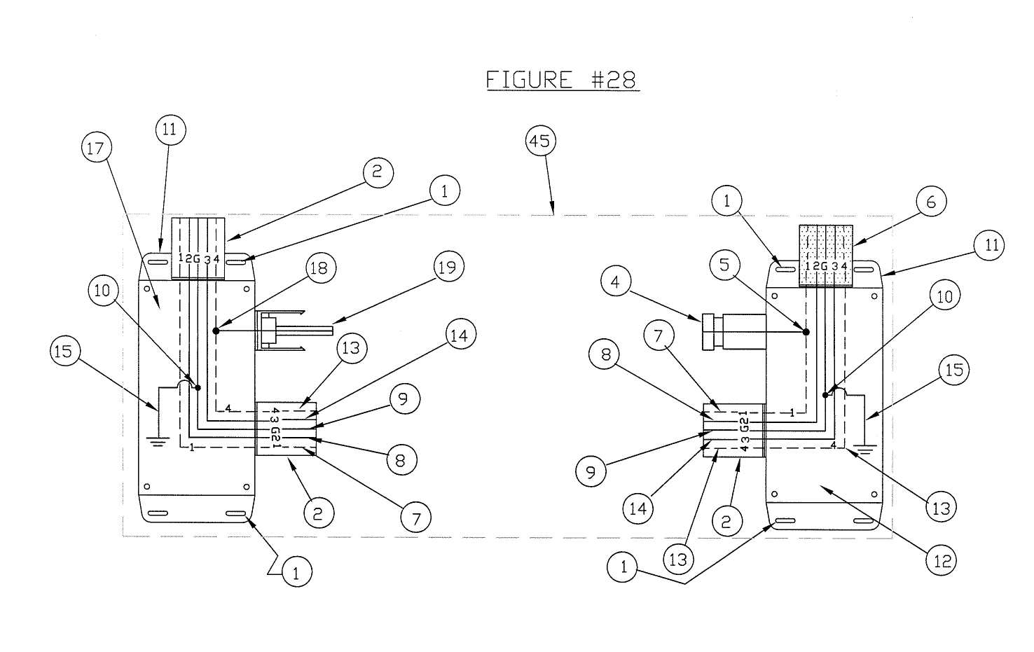

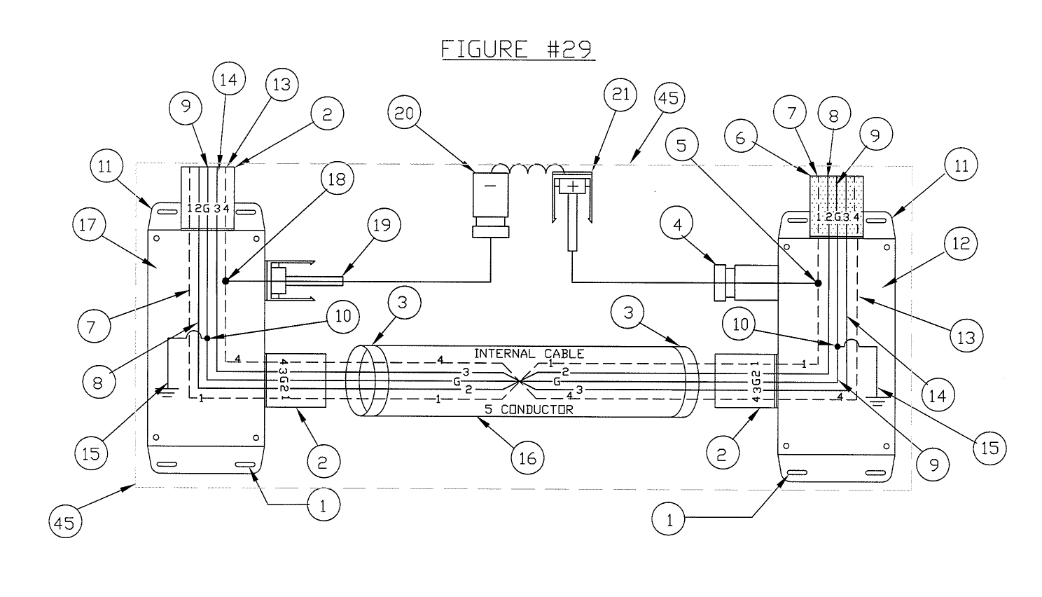

In the XJR Junction Box-Right Side, there is a Negative Photovoltaic Connector that receives the Current from the Positive Photovoltaic Connector of the Photovoltaic Module and the wire from the Negative Connector splices into the #1 wire inside the XJR Junction Box. (See FIGS. 4 29).

In the XJR Junction Box-Left Side, there is a Positive Photovoltaic Connector that receives the Current from the Negative Photovoltaic Connector of the Photovoltaic Module and the wire from the Positive Connector splices into the #4 wire inside the XJR Junction Box. (See FIGS. , ).

### Starter Plug

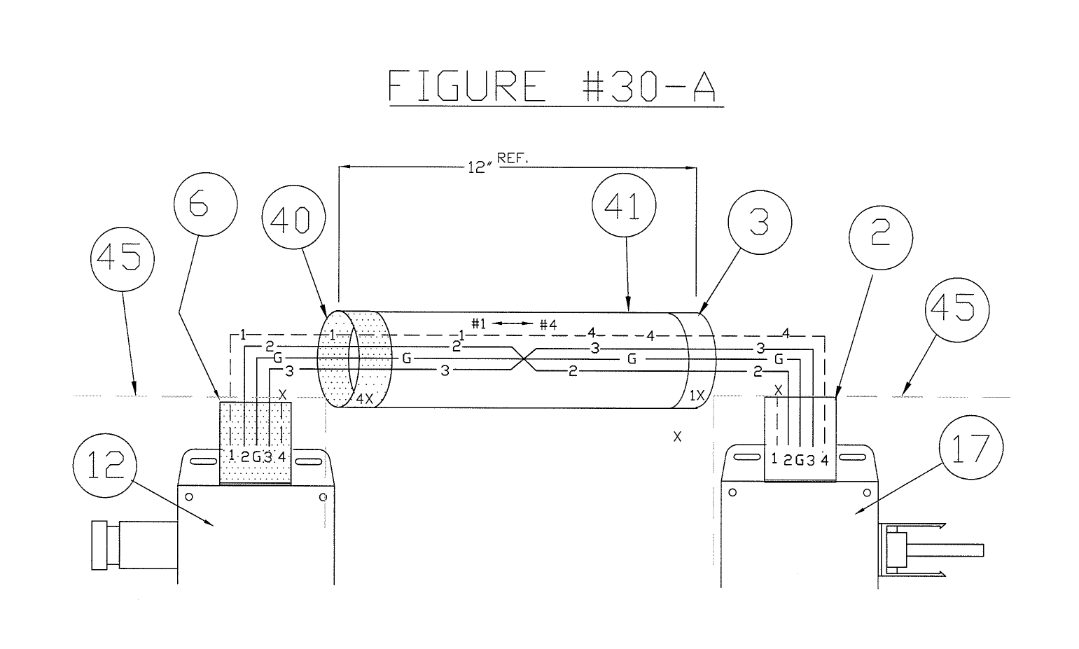

Inside the Starter Plug is a Wire attached between the #1 and #2 pins. (See FIG. 27).

Inside the Starter Plug is a Wire attached between the #3 and #4 pins. (See FIG. 27).

### In-Series Wiring Configuration

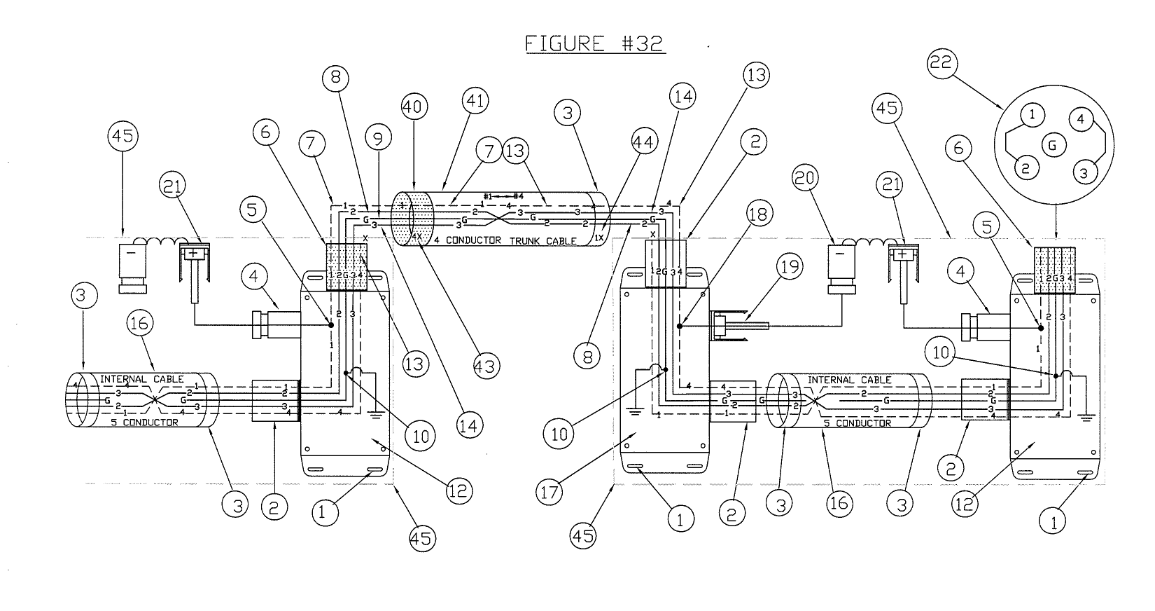

The 12″ Trunk Cable for a String Installation wired in an In-series Wiring Configuration has a Female 5 pin connector at each end and is Color-coded with one Connector being Clear/Non-colored and the other Connector being RED. (See FIG. 30A).

In the Trunk Cable for a string installation wired in an In-series Wiring Configuration, the wire from the #4 pin on the Clear/Non-colored Side will attach to the #1 pin on the RED Side. (See FIG. 30A)

The 12″ Trunk Cable for a String Installation wired in an In-series Wiring Configuration will not have a wire attached to the #1 pin in the connector on the Clear/Non-colored Side or the #4 pin in the connector on the RED side. (See FIG. 30A)

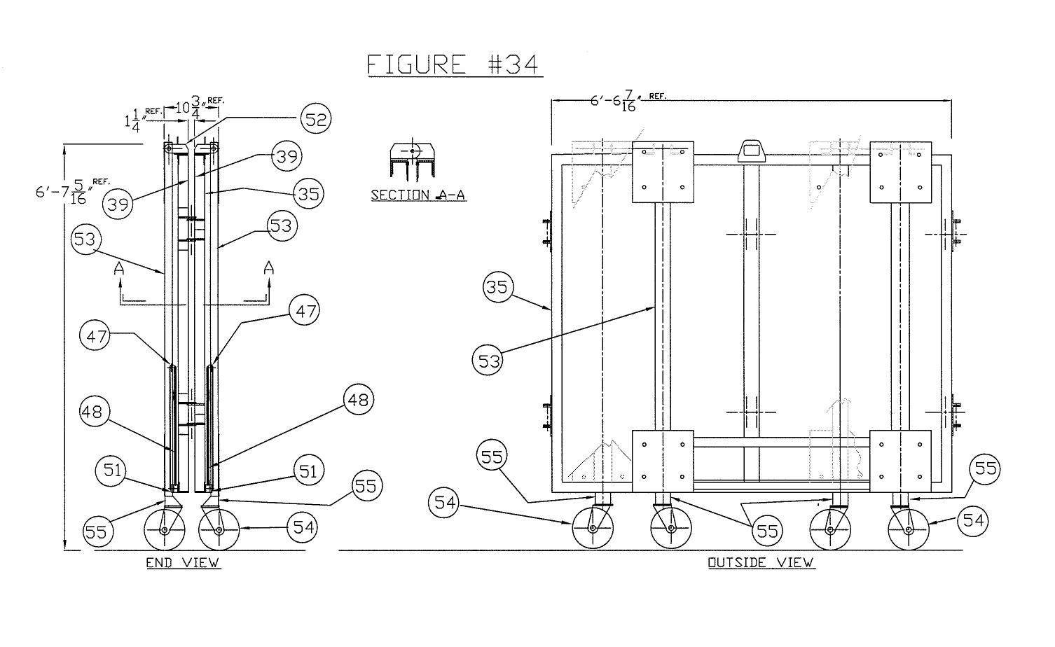

The current through the #2, #5 and #3 pins in the Trunk Cable of a 3 PPG string that is wired in an In-series Wiring Configuration will never be interrupted. (See FIGS. 30, 30A, 32)

By using the Starter Plug on the right side, when viewed from the back, the positive current goes from the #1 pin to the #2 pin in the Starter Plug and the #2 wire carries the positive current to the left side of the end of the third PPG unit. (See FIGS. 27, 30, 32)

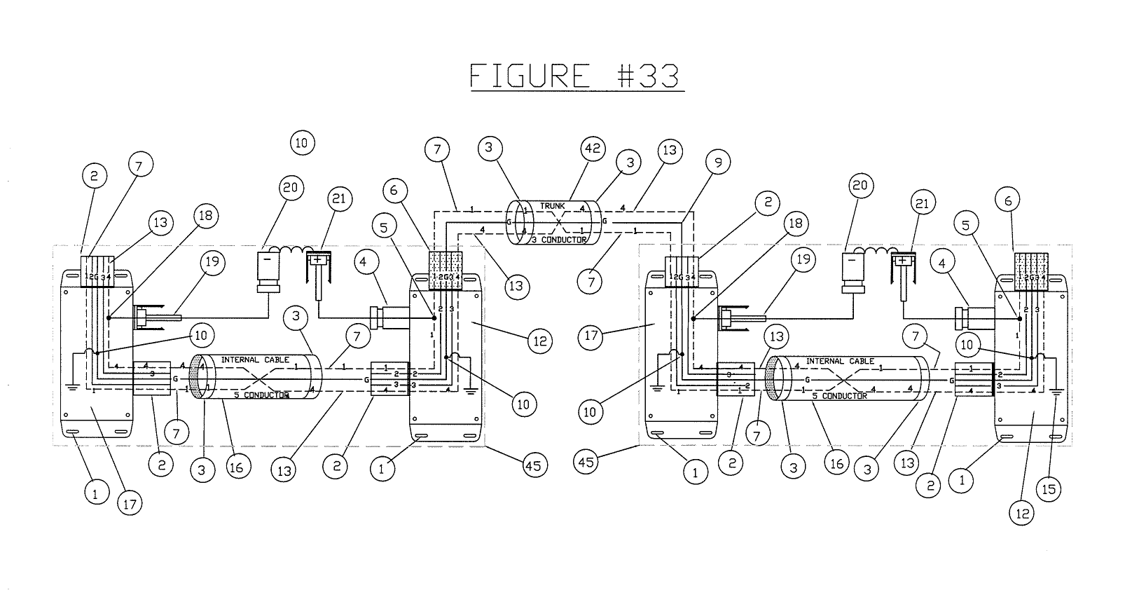

By using the Starter Plug on the left side, when viewed from the back, the negative current goes from the #4 pin to the #3 pin in the Starter Plug and the #3 wire carries the negative current to the right side of the end of the third PPG unit. (See FIGS. 27, 30, 31)

Two 12″ long In-series Wiring configuration Trunk Cables consisting of a 4-conductor wire with a RED Color-coded Connector on one side, is provided for every three PPG units wired in an In-series Wiring Configuration. (See FIG. 30A)

### In-Parallel Wiring Configuration

There are no changes required when connecting two PPGS in an In-parallel Wiring Configuration after having been connected in a three PPG In-series Wiring Configuration to one another. (See FIG. 33)

No Starter Plug is required when two PPG units are connected in an in-parallel Wiring Configuration. (See FIG. 33) The parallel trunk cable is a 3-conductor 12 AWG wire. (See FIG. 33)

### Built-In Fold-Out Windscreen

The PPG, when lying on the ground in the open position, is ready to have the upper surface raised to the solar production angle of attack to the sun as the final step of setting up. (See FIG. 37)

With one person in back of Each Section (there are two Photovoltaic Modules in each Section) the Upper Level containing Photovoltaic Modules is lifted to its full operational position. (See FIG. 37)

As the top Photovoltaic Portion of each Section goes up, Support Channels of each Section unfold and drop down to support the top Photovoltaic Side in place. (See FIG. 37)

Attached to the Support Channels is a Thin Aluminum Sheet covering the whole exposed open rear area between the Upper Main Frame containing Photovoltaic Modules and the Lower Base Frame.

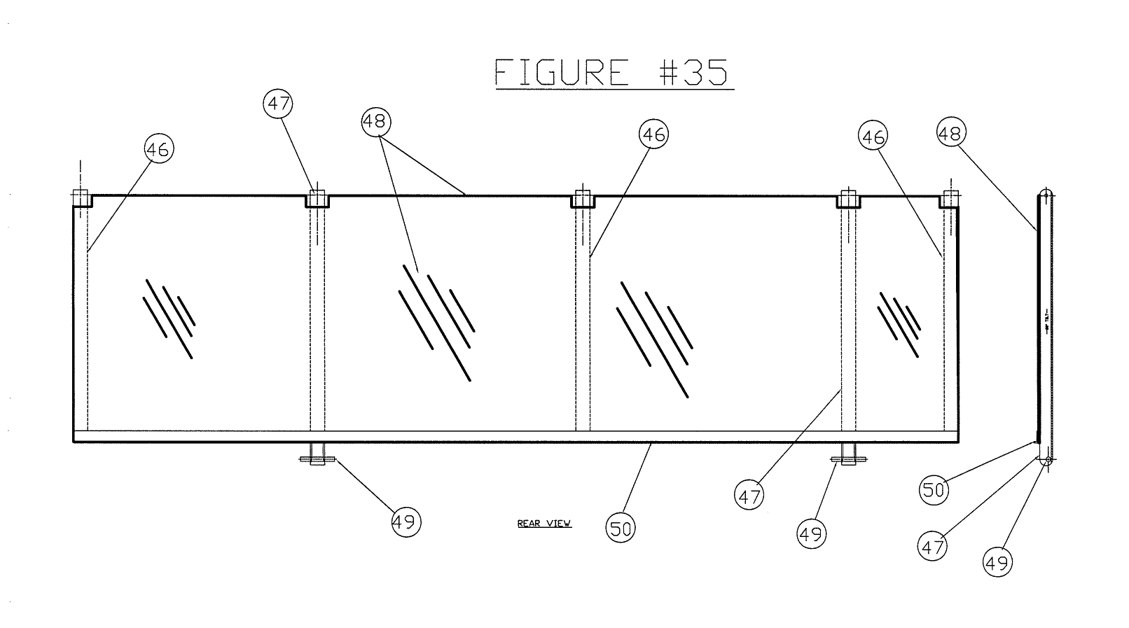

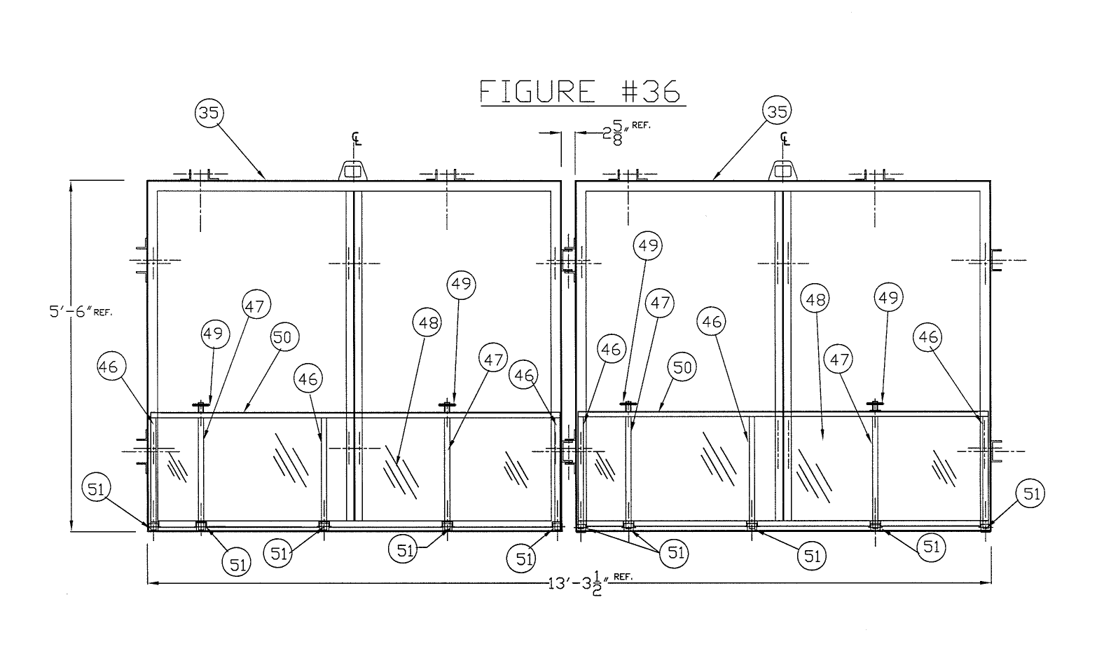

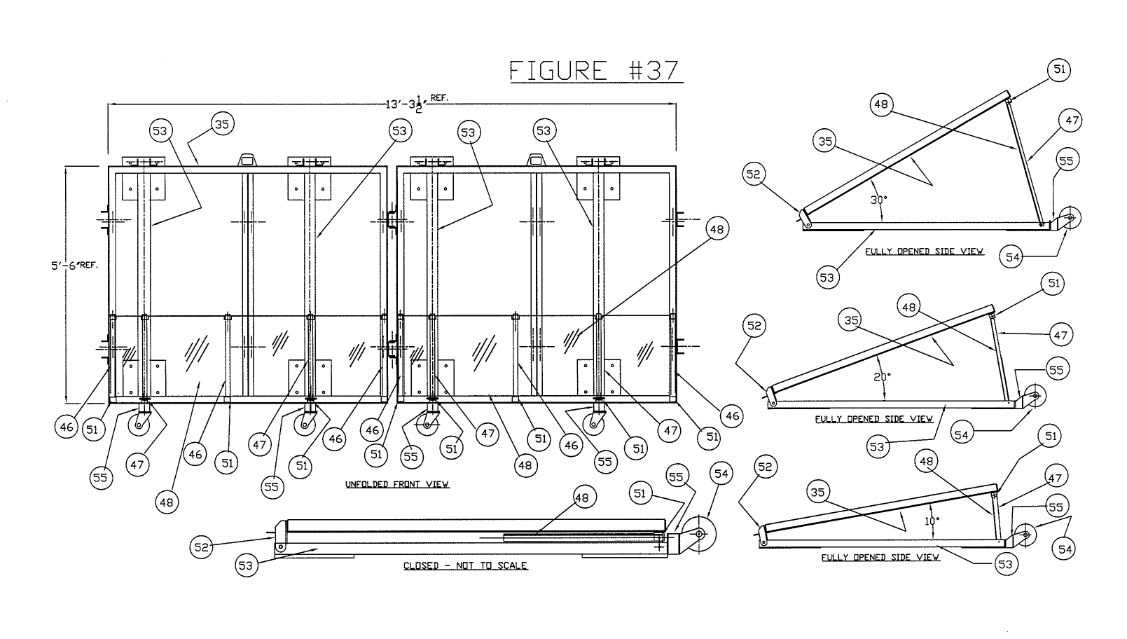

The positioned Thin Aluminum Sheet now becomes the Unfolded Windscreen; keeping the wind from getting under the Main Frame with the Modules while Reducing the Need for Ballast. (See FIGS. 34, 35, 36, 37)

When the PPG is required to Relocate to Another Site, the PPG is first Disconnected from the Load, closed, and with its Windscreen Folded between the Base Frame and the Main Frame, is standing on its Flat Free 8″ Swivel Caster Wheels in its Travel Configuration, ready for Rapid Deployment to where power is needed. (See FIGS. 34, 36, 37)

### Anti-Theft Quick Release Quick Detachable Caster Wheels

All four 8″ Swivel Caster wheels are individually attached to a Quick Release Quick Detachable Housing Unit that locates itself to a Double Barrel Mounting Bracket that is designed to receive two Positive Locking Pins, each to secure a Quick Release Quick Detachable Housing Unit in place.

There are four Double Barrel Mounting Brackets in each PPG, one attached to the end of each Base Frame Channel. (See FIGS. 34, 37)

TABLE 1
IDENTIFICATION OF ITEM NUMBERS IN DRAWINGS

| | |
|---|---|
| 1. | Mounting Slot with WEEB-type Washer |
| 2. | Female 5-Pin Connector |
| 3. | Male 5-Pin Connector |
| 4. | Negative Photovoltaic Connector |
| 5. | Positive Current Splice to (7) Positive Wire #1 |
| 6. | Red Color-coded Female 5-Pin Connector |
| 7. | Positive Wire #1 |
| 8. | Positive Wire #2 |
| 9. | Ground Wire |
| 10. | Internal XJR Junction Box Ground Splice to (9) Ground Wire |
| 11. | XJR Junction Box Cover Plate |
| 12. | XJR Junction Box-Right Side |
| 13. | Negative Wire #4 |
| 14. | Negative Wire #3 |
| 15. | Ground Wire from (11) Cover Plate |
| 16. | Internal Trunk Cable |
| 17. | XJR Junction Box-Left Side |
| 18. | Negative Current Splice to (13) Negative Wire #4 |
| 19. | Positive Photovoltaic Connector |
| 20. | Photovoltaic Module Negative Current Source |
| 21. | Photovoltaic Module Positive Current Source |
| 22. | Starter Plug |
| 23. | Jumper Wire Loop Connecting Current Between |
| | Pin #3 (25) and Pin #4 (24) |
| 24. | Internal Pin #4 |
| 25. | Internal Pin #3 |
| 26. | External Pin #2 |
| 27. | External Pin #3 |
| 28. | External Pin #2 |
| 29. | External Pin #1 |
| 30. | Internal Pin #2 |
| 31. | Internal Pin #1 |
| 32. | Internal Wire Loop Connecting Current Between |
| | Pin #1 (31) and Pin #2 (30) |
| 33. | Photovoltaic Positive Connector (21) Attached |
| | to (12) XJR Junction Box-Right Side (12) |
| 34. | Internal Trunk Cable (16) Attached to |
| | XJR Junction Box-Right Side (12) |
| 35. | PPG Aluminum Frame |
| 36. | Photovoltaic Module Connectors Negative to Positive Connection |
| 37. | (20) Photovoltaic Module Negative Connector |
| | Attached to (17) XJR Junction Box-Left Side |
| 38. | (16) Internal Trunk Cable Attached |
| | to (17) XJR Junction Box-Left Side |
| 39. | Photovoltaic Module |
| 40. | Color-Coded 5-Pin Male Connector |
| 41. | In-series Wiring Configuration Trunk Cable |
| 42. | In-parallel Wiring Configuration Trunk Cable |
| 43. | Negative Wire Not Used |
| 44. | Positive Wire Not Used |
| 45. | PPG Delineation |
| 46. | Windscreen Stiffener |
| 47. | Support Channel Assembly |
| 48. | Windscreen |
| 49. | Plastic Guide Rod |
| 50. | Kick Rail |
| 51. | Support Rod Hinge |
| 52. | Master Hinge |
| 53. | Base Frame |
| 54. | 8″ Flat Free Swivel Caster Wheel |
| 55. | Quick Release Quick Detachable Caster Wheel Assembly |

What is claimed is:

1. A portable solar energy electrical power generating system comprising:
a) a plurality of modular solar energy collecting units wherein each modular solar energy collecting unit comprises a photovoltaic solar panel that converts solar energy to DC electrical power;
b) a master assembly unit for the plurality of modular solar energy collecting units comprising a frame generally rectangular in shape adapted to receive the plurality of modular solar energy collecting units; and
c) a base assembly unit adapted to receive the master assembly unit.

2. The portable solar electric power energy electrical generating system of claim 1 further comprising a plurality of micro-inverters integral with the solar energy collection units.

3. The portable solar electric energy power generating system of claim 2 wherein each of the plurality of micro-inverters is mounted to the frame near the respective photovoltaic solar panel.

4. The portable solar electric energy power generating system of claim 2 further comprising an electrical receptacle box located in close proximity to the plurality of modular solar energy collecting units that receives the AC electrical power from the plurality of modular solar energy collecting units and makes the AC electrical power available through standard electrical plugs.

5. The portable solar energy electric power generating system of claim 1 wherein the master assembly unit further comprises a hinge so that the system may be reversibly folded about the hinge for transport of the solar energy generating system.

6. The portable solar energy electric power generating system of claim 1 wherein the system further comprises casters mounted to the bottom of the system for transport of the system.

7. The portable solar energy electric power generating system of claim 1 wherein the system further comprises a plurality of rivets that fix the plurality of modular solar energy collecting units to the master assembly unit.

8. A portable solar energy electrical generating system comprising a plurality of modular solar energy collecting units wherein each modular solar energy collecting unit comprises a photovoltaic solar panel that converts solar energy to DC electrical power and a removable micro-inverter for converting the DC electrical power to AC electrical power, a master assembly unit for the plurality of modular solar energy collecting units comprising a frame generally rectangular in shape adapted to receive the plurality of modular solar energy collecting units, a base assembly Unit adapted to receive the master assembly unit, and an electrical receptacle located in close proximity to the plurality of modular solar energy collecting units that receives the AC electrical power from the plurality of modular solar energy collecting units and makes the AC electrical power available through standard electrical plugs;
Wherein upon removal of the micro-inverter, the portable solar energy solar electrical generating system is a fully functional DC power generating system.
